(19) United States
(12) Patent Application Publication
(10) Pub. No.: US 2012/0078870 A1
(43) Pub. Date: Mar. 29, 2012

(54) APPARATUS AND METHOD FOR COLLABORATIVE SOCIAL SEARCH

(76) Inventor: Gaurav Bazaz, Manlius, NY (US)

(21) Appl. No.: 13/246,862

(22) Filed: Sep. 28, 2011

Related U.S. Application Data
(60) Provisional application No. 61/387,062, filed on Sep. 28, 2010.

(51) Int. Cl. G06F 17/30

(52) U.S. Cl. 707/706; 707/E17.108

(57) ABSTRACT

A system is provided for allowing collaboration among users while they conduct information searches. The system allows users to share their search queries and see what other users are searching for. This is accomplished by copying the search queries of users to a message board type activity stream where a user can see other users' search queries. In the process it allows users to help other users by providing guidance and additional information on their queries or in other ways by responding to other users' search queries. Additionally, a system is provided to allow users to discover other users who are searching for the same information concurrently, and a system that shows other users that the current user has included in his or her sharing network who have previously searched for the same information.

### RELATED APPLICATION

This application claims the benefit of priority to U.S. Provisional Application 61/387,062 filed 28 Sep. 2010, the entire disclosure of which is incorporated by reference.

### FIELD OF THE INVENTION

The present invention relates to collaborative and publicly shared information search and discovery on the World Wide Web and other information storage media.

### BACKGROUND

Present search models allow computer algorithm (machine based) searching of data stored on one or more computer data repositories. The most common search is conducted by a web search engine designed to search for information on the World Wide Web. The search results are typically presented as a list, called hits, and consist of web pages, images and other types of files. Other search engines also mine data available in private databases and/or open directories. However, all current search models limit the user by returning only the data the search engine's algorithms determine to be most relevant. In many cases, the information so returned to user, is outdated, incorrect, incomplete or otherwise inappropriate for the user. In addition, in many cases, the user can benefit considerably from the opinion or personal experience of other people, especially people the user already has a relation with, with respect to the user's information search. Current search models do not allow the user to gain the benefit of knowledge and opinion of other people while the user is searching and do not allow other people to intervene and add information, nuance or value in other ways, to the user's information discovery process. By keeping every user's information search process independent and separate of every other user, the current search models deny the potential for collaboration among people in the information search process and fail to create considerable potential value for their users. The present invention solves this problem by providing various models to allow collaboration among people while engaged in information search processes.

### SUMMARY OF INVENTION

When a user enters a query into a web search engine (typically by using keywords), the engine examines an index (of data about web pages previously retrieved and stored in an index database) and provides a listing of best-matching web pages according to its search algorithm; it usually provides a short summary containing the document's title and part of the text of the document itself. In contrast, an enterprise search is a search of information within an organization (although the search function and its results may be public). An enterprise search is based on index data and search documents from a variety of sources such as: file systems, intranets, document management systems, e-mail and databases, which is then presented in a consolidated list of relevance ranked resources from these various sources.

When searching for information or an answer to a specific question, many people rely on and contact the people they know—their colleagues, friends and acquaintances. They may call, text, email or engage others on a social network such as Facebook® or Linkedln®. However, there is currently no convenient method for searching both information repositories on machines, as well as other people's knowledge, simultaneously.

As used herein, a query is any search item or question that the user is trying to gather information on by searching an information repository (such as the World Wide Web or some database)

As used herein, a sharing network is a group of other users with whom the current user has chosen to share his or her search queries so that his or her search queries are sent to their query feed, and whose search queries the user receives in his or her own query feed if allowed by them.

As used herein, a query feed is a list of near real time notifications displayed to a user in his or her user interface display, usually ordered in reverse chronological order (most recent first) and continuously updated as new notifications are generated, and consisting almost entirely of queries and questions generated by other users in the user's sharing network and replies to those queries.

As used herein, near real time means follow up event happens nearly instantaneously or very soon after the triggering event. For instance, new items show on the query feed nearly instantaneously with the item creator entering it on his or her interface display. Similarly, questions get answered very soon after they are sent out or within the same user session.

As used herein, a subnet is a group of users, who have a defined interest, knowledge or expertise in a given area and have chosen to receive search queries from other users related to the given area even if those users are not part of their sharing network.

In accordance with one embodiment of the present invention, an apparatus and method are provided for conducting both a machine based search and a socially shared search simultaneously. A user enters a search query for a machine-based search of information repositories. The search query is supplied to a search engine and is also supplied to a network of people identified by the user whereby the network members can provide their own responses or comments on the search query. A user's queries are sent to other people via “feeds”, and queries by others in the user's sharing network are also sent to the user, creating a “collaborative search” environment where search queries are shared between users allowing them to develop conversations around their respective search queries and create opportunities for spontaneous collaboration.

Thus, according to the present invention a mechanism is provided to share search requests with a network of people. The mechanism allows users of the network to help other users with information discovery. The network members are allowed to view and learn from and in other ways participate in a user's information discovery activities based on queries made to a search engine, which engine then searches the World Wide Web or information on various private or public data repositories. The apparatus and method allows each user to view interactions happening around information search queries created or entered by themselves or other people in their network. The benefits of the present invention are:
cooperative, collaborative information search and discovery;
users can help each other add new information, nuance, depth and clarity to information available from machine stored documents;
users can see other user's queries and questions and find interesting things other people are looking for or learning about;
users can learn what other people are doing and working on by seeing their searches; users can receive help on their information searches and get their questions answered by other people in real time;
users can tell other individuals what activity the user is engaged in, with no need for the user to write messages to other individuals.

In various embodiments, the apparatus includes a back-end search engine which searches through information in a repository such as the World Wide Web and delivers results to the user based on the user's query. It creates a sharing network that relates users of the system to each other based on their selections. It includes a messaging system that takes a given user's search queries as input and transmits them to all other users on the system who comprise that user's sharing network. A user interface allows the user to run queries in a search engine while at the same time allowing the user to view queries made by the other users and transmit his or her searches to other users automatically. The messaging system and user interface components allow users to view and comment on each other's queries as well as interact with them in other ways such as writing back replies, forwarding them or voting on them.

In various embodiments, the search engine can search internal or enterprise databases. In addition, the search engine may comprise multiple search engines, such as Google® for searching the web, Amazon® for products, DMOZ® for directory listings, etc. The results of the search engine and the sharing network results may be displayed either separately or together.

In various embodiments, the present invention may be incorporated into existing products such as existing such search engines or social networks. In case of existing search engines, this can be achieved in two ways. Either by means of a browser plug-in, which inserts the shared search queries into the search results pages of the search engines, using client side (browser based) code or by means of server side code which incorporates a query sharing module within the search engine to enable the display of shares search queries within regular search engine results pages. In case of social networks, users can share their search queries from other search engines or from within the social network interface by enabling software code that catches the search queries as they are made within or outside the social network product and transmits them to the social network messaging system so they can be shared with the user's sharing network on the social network system.

The operation of the present invention, in one possible embodiment, can be explained through an illustrative use case. Suppose a user runs a search query for ‘fried chicken recipes’. In case of a generic search engine such as Google®, the user will receive various recipes available on the web, ranked according to relevance based on the search engine's ranking algorithm. However, in case of the present invention, in one possible embodiment, when the user runs the same search query, the user will receive a set of web results rank ordered according to the search engine's algorithm, but the search query will also be shared with other users who the current user has included in his or her sharing network. When other users see the query, they can respond by suggesting their own recipes, links to recipes they used, or in other ways—in each case making the overall experience for the user a more productive and positive one.

The present invention allows users to share their search queries with their sharing network. But in some cases, the user's network is unlikely to have the answer to the query or find it interesting. In these cases, the user can ‘push’ his or her query to a ‘subnet’. A subnet is a group of users, who have a defined interest, knowledge or expertise in a given area. For instance, the Astronomy subnet will be subscribed to by people who have considerable interest, knowledge or expertise in Astronomy. When a user has a query pertaining to Astronomy (eg: ‘world's largest telescope’), they can push the query to the Astronomy subnet. When they do so, the query will show up on the query feed of all people subscribed to the Astronomy subnet. And they can reply with their answers, suggestions, comments and guidance. By using the subnet, the user is able to reach out to a larger group of people whom he or she doesn't know and who don't belong to his or her pre-defined sharing network. In addition, users who do not create a sharing network for themselves (by importing from external sources or manually within the embodiment of the invention), can still take advantage of all features of the system by subscribing to subnets that interest them (to receive other user's queries in their query feed) and pushing their queries to subnets relevant to the question (to get answers and responses to their queries from other users).

Additionally, the present invention proposes a model to allow users to better control the nature of results presented by search engines by allowing the users to control the algorithm by changing the weightings assigned to different parameters factored into the search engine algorithm. For instance, the user can increase or decrease the importance of keywords, inbound links, page freshness and other parameters to change the rank ordering of the results presented by the generic algorithm to better suit the user's requirements. In a particular embodiment of the invention, this model can be implemented by providing the user with a simple tracker element in the interface which the user can modify to change the weightings assigned to each parameter.

Additionally, the present invention proposes a model to further facilitate collaboration in information search by disclosing an innovation where users searching for a particular item on a search engine can see a list of other users who are also searching for the same item or similar items concurrently, or had searched for same or similar items recently, on the same or interlinked search engine system. These other users can include those within the user's sharing network or outside such network. This present innovation allows a user to find other users who are engaged in the same information search process and collaborate with them to achieve various objectives.

Additionally, the present invention proposes a model to improve the search experience of a user by allowing the user to see a list of users in his or her sharing network who have previously searched for the same item or similar item on the same or another interlinked search engine system. The searches could have been carried out by these other users from the current user's sharing network concurrently, on the same day, in the same week or any other time frame. This innovation allows the user to consider getting their opinion or guidance on his or her current information search.

Additionally, some additional features are proposed that facilitate the user experience of a user using an embodiment of the present invention including the ability to search anonymously, whereby the search query of the user is shared with the user's sharing network, but the user's identity is not disclosed to members of the user's sharing network. Also a feature that allows a user to add simple text commands with his search query is disclosed, where such commands control the behavior of the given embodiment of the present invention. For instance, a user can add a few extra characters such as ‘/vid’ which direct the system to return video results only.

Modifications can be made to the below described embodiments of the present invention without departing from the scope of the invention, the embodiments being illustrative and not restrictive.

As will be appreciated by one skilled in the art, the present invention may be embodied as an apparatus and/or method, including a computer program product. It may take the form of hardware, software (including firmware, resident software, microcode, etc.) or an embodiment combining software and hardware. The invention may take the form of a computer program product embodied in a tangible medium of expression having computer-usable product code stored in the medium. The code may be written in any of various programming languages such as Java, PHP, C++, C#, Javascript and other programming languages. As used herein, database is not meant to be limiting, and can reside in one or more location and/or data repositories. The invention has been described below with respect to flow chart illustrations and/or block diagrams of methods and user interfaces, apparatus (systems) and computer program products according to various embodiments of the invention. It will be understood that each block of the flow chart and/or block diagram can be implemented by computer programming instructions. These instructions can be provided to a processor of a general purpose computer, special purpose computer or other programmable data processing apparatus for implementing the function/acts specified in the flow chart and/or block diagrams. The flow charts and block diagrams are not limited by the architecture, functionality, operation, and/or step order disclosed. By way of example only, the described embodiments may be implemented on various computer servers such as any x86_{—}64 processor based server, for example running Windows Operating System. The database programming may be implemented for example, in the SQL programming language.

### BRIEF DESCRIPTION OF THE DRAWINGS

Various embodiments of the present invention will now be described with reference to the attached drawings, in which:

FIG. 1 is a flow chart illustrating one embodiment of a system workflow. A user creates an account on the system. The user then creates his or her sharing network, which the user can do manually or automatically by importing data from another source.

FIG. 2 is a flowchart describing a system workflow according to one embodiment of the invention. User A enters a search query in the system. The system returns the query search results from one or more data repositories, such as the World Wide Web. The query is also shared with user A's sharing network, with or without delay. Other users on the system, who are in user A's sharing network see user A's query on their display. Other users on the system who are in user A's sharing network, can reply to and comment on user A's query. User A can respond to the other responses and comments within the system.

FIG. 3 is a schematic block diagram of a dataflow according to another embodiment of the invention. Here, the user enters a search query and the search is sent both to a search engine module, which module returns results from an information repository, and the search query is sent to the user's sharing network, with or without delay, whereby other user's on the system can write replies, which are returned to all users in the original user's network.

FIG. 4 is a mock-up of the user interface according to one embodiment of the present invention. The interface, here a Web portal, includes left and right display windows. At the top of the left display, there is a text box for the user to enter a search query. The user has the option to either share or not share (by clicking the Private button) a given search query with the user's sharing network. The user then clicks the Search button and a search is conducted by the Web search engine, and the results returned in the left display window. The search query entered by the user is displayed in the right panel and shared with other users in the user's sharing network.

At the top of the right display window is a text box for the user to enter a question to be sent to the user's sharing network and/or one or more selected subnets. Below this text box is a listing of search queries and replies, the replies being grouped together according to the associated query. The search queries in this display window form the ‘Query Feed’ which is the list of all queries conducted by users in the current user's sharing network, that were shared by them. It also includes the queries conducted by the current user himself. Thereby, this display window displays all the queries being run by the users in the current user's sharing network allowing the users to collaborate and work together around these search queries. The listing includes an identification of the network member who searched or replied, an indication of when the query or reply was made, and a Reply button for sending a reply message.

FIG. 5 is a mock-up of some elements of the query feed user interface according to one embodiment of the present invention.

FIG. 6 is a mock-up of the user interface of another embodiment of the present invention wherein the query feed is embedded within an existing generic search engine either through server side code or client side code such as a browser plug-in. This embodiment allows users to continue to use their preferred search engine while also drawing benefit of the collaborative model developed in the present invention through the embedded query feed.

FIG. 7 is a mock-up of the user interface of another embodiment of the present invention wherein the query feed developed in the present invention is incorporated within the social information feed of a generic social network system. This embodiment allows the users to continue to use their preferred social network product and draw the benefit of the innovation of the present invention from within the interface and system of their preferred social network system. In this embodiment, while the search queries are shared within the generic social network system, the queries are captured from within the social network system or from user activity outside the social network system using interlinking code that transmits user's search queries from the point where they are conducted to the social network system.

FIG. 8 is a mock-up of the user interface of another embodiment of the present invention wherein the query feed is incorporated into the search module of a generic social network system. In this embodiment the search is conducted within the social network system.

FIG. 9 is a mock-up of the user interface according to a particular embodiment of another innovation of the present invention wherein a user can control the search algorithm used by the search engine to rank order results by controlling the weightings assigned to different parameters factored into the search algorithm.

FIG. 10 is a mock-up of the user interface according to a particular embodiment of another innovation of the present invention wherein a user can see a list of other users who are currently searching for the same item the user is searching for. These other users can include those within the user's sharing network or outside such network. The innovation in this particular embodiment is embedded within a generic search engine allowing the user to continue to use his preferred search engine, while creating the opportunity for user to collaborate with other users who are engaged in the same or similar information search.

FIG. 11 is a mock-up of the user interface according to a particular embodiment of another innovation of the present invention wherein a user can see other users who belong to the user's sharing network who have searched for the same item in the past. The searches could have been carried out by these other users from the current user's sharing network concurrently, on the same day, in the same week or any other time frame. This innovation allows the user to consider getting their opinion or guidance on his current information search. The innovation in this particular embodiment is embedded within a generic search engine allowing the user to continue to use his preferred search engine, while creating the opportunity for user to collaborate with other users from his sharing network who have engaged in the same or similar information search in the past.

### DETAILED DESCRIPTION

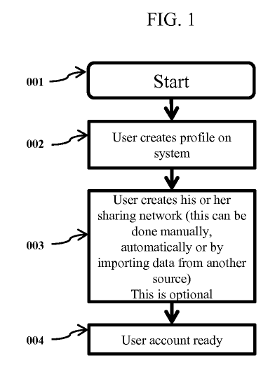

FIG. 1 is flow chart illustrating the system workflow according to one embodiment of the present invention. This workflow describes the creation of an account by a user with the system implementing the present invention. The user starts at 001 wherein he visits the registration page for the system. At the registration page, the user creates a profile for himself on the system in step 002. Next, at 003 the user creates a sharing network on the system wherein the user selects other system users with whom the user wishes to share his search queries and whose search queries he wants to receive in his query feed. Once the user crosses 003, the user account is ready for use at 004.

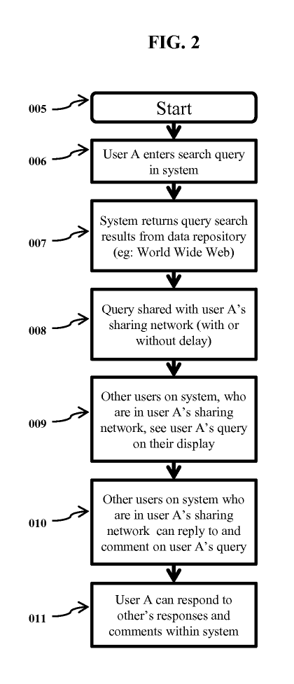

FIG. 2 is a flowchart describing a system workflow according to one embodiment of the present invention. This flowchart describes the operation of the search query sharing model. The process starts at 005 where the user is logged into the system and system has identified the user. At 006, the user enters a search query in the system. The search engine responds by returning the appropriate results from the data repository such as the World Wide Web at 007. Next at 008, the system copies the user's search query to his sharing network, so other users in his sharing network can see what the user is searching for as the user's search query appears in their query feed with or without delay. At 009, these other users in the current user's sharing network see the search query of the user as it shows on their displays. At 010, these users can reply to and otherwise comment on the current user's search query and also replies to the query. This is where the model adds value as it creates opportunities for spontaneous collaboration. Finally, at 011, the current user can respond to the replies to his original search query and gather more information regarding the search item from people in his network who are users of the system.

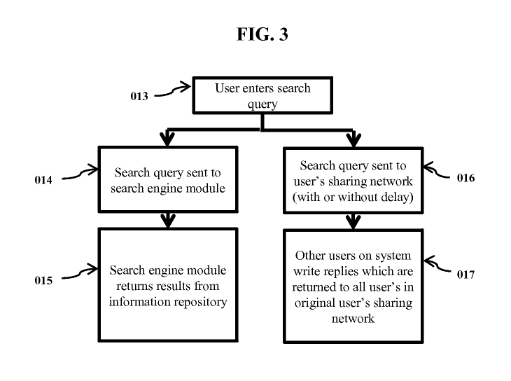

FIG. 3 is a schematic block diagram of a dataflow according to another embodiment of the present invention. The process starts at 013 when the user enters the search query. The query can be entered into a form which is hosted within a separate system dedicated to implementation of the present invention or in existing generic search engines or social networks. Next, the search query is sent to the search engine module at 014, which in turn returns the machine determined results consisting of links, files and documents that the search engine algorithm determines to be relevant to the user's query, in 015. Simultaneously, the search query is sent to the user's sharing network through a messaging system at 016, whereby the query becomes visible to all the users who are in the current user's sharing network, in their respective query feeds. Next, the users in the current user's sharing network can write replies which are returned by the messaging system to all users who received the original query, at 017.

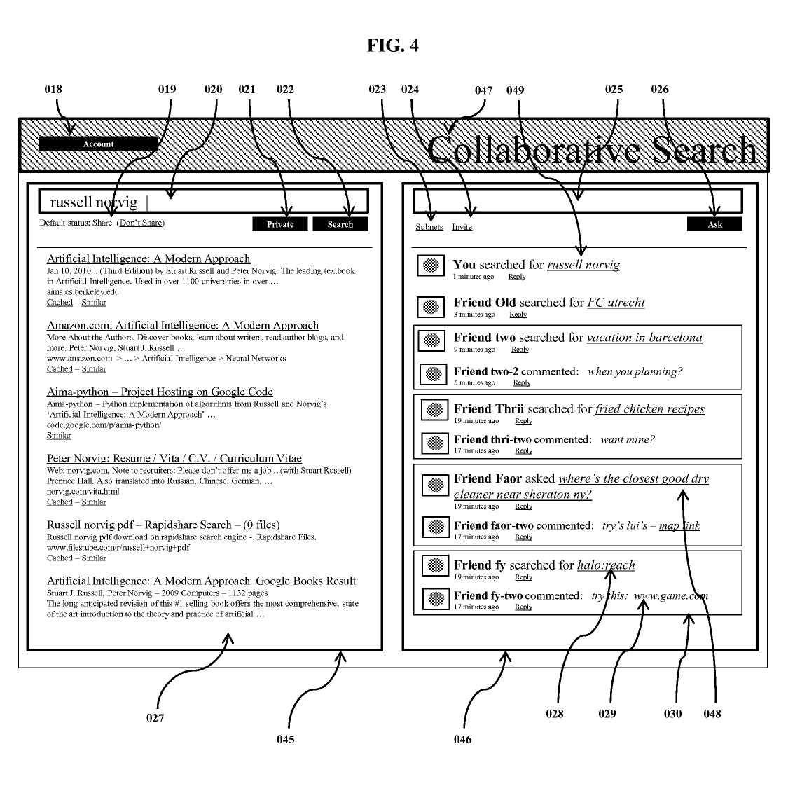

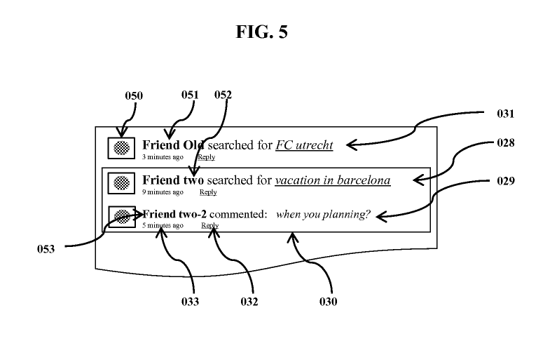

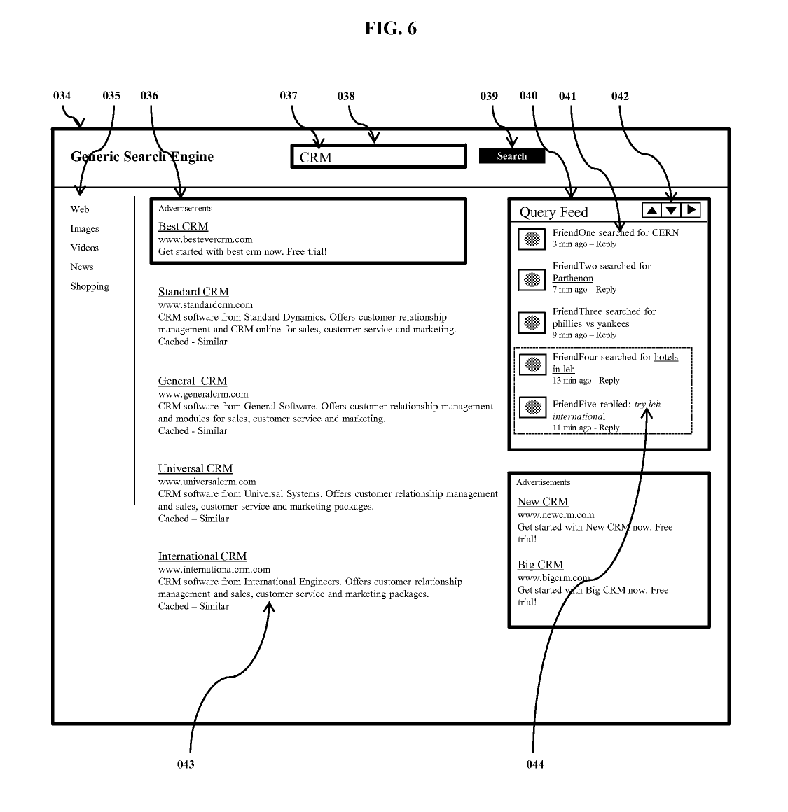

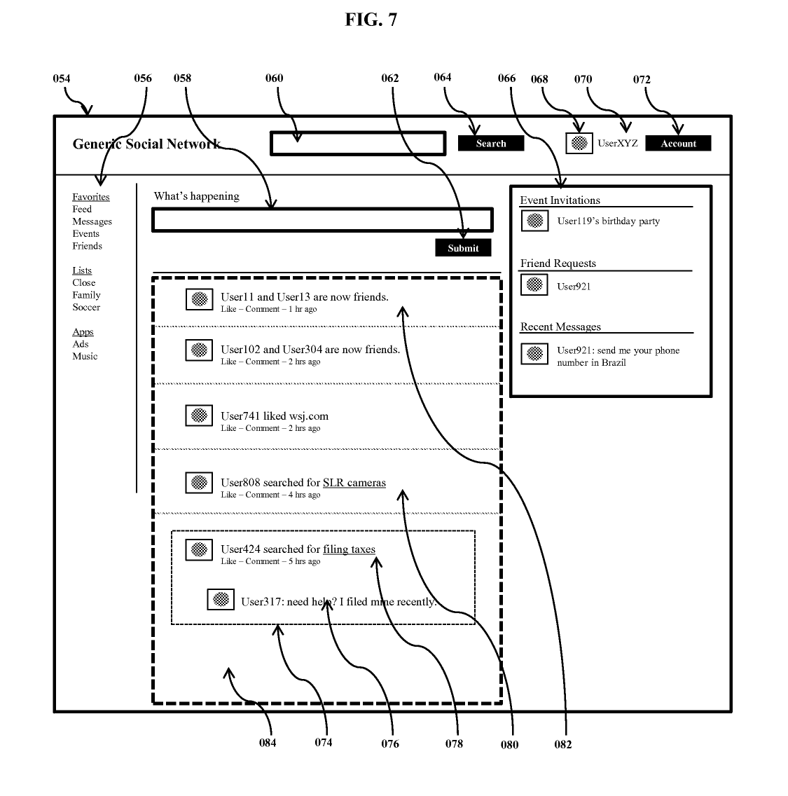

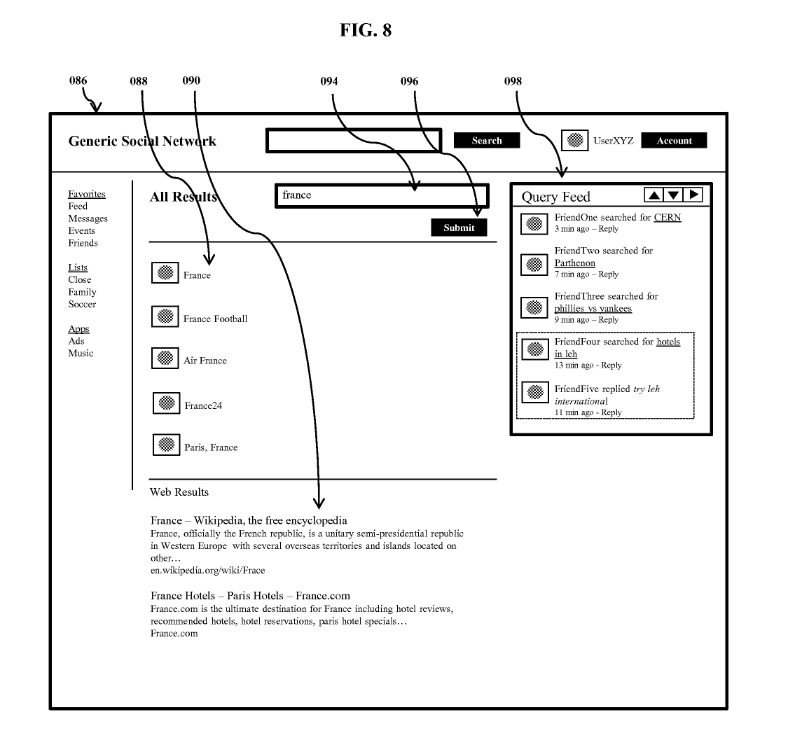

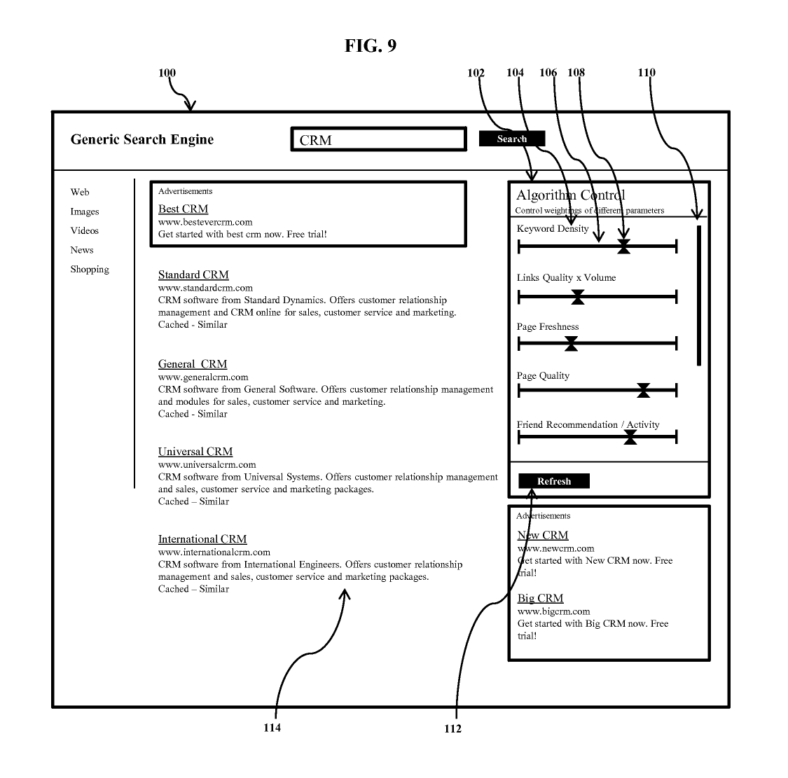

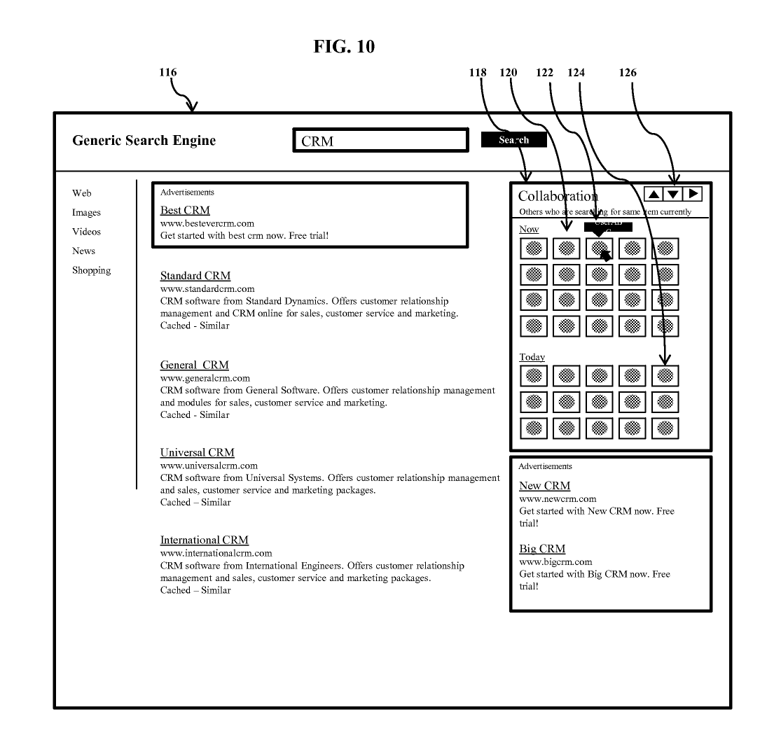

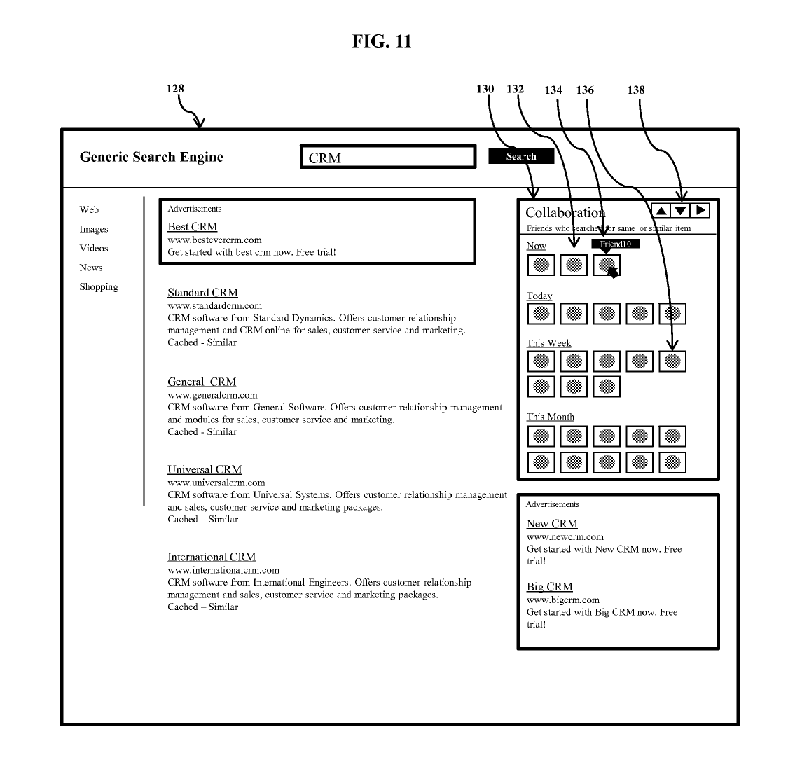

FIG. 4 is a mock-up of the user interface according to one embodiment of the present invention. The interface consists of a header panel 047 and another two panels 045 and 046. The header panel 047 holds the product name in this embodiment and a button 018 that allows the users to modify their account settings. The left panel 045 is the search results panel and the right panel 046 is the query feed panel. The search box 020 is where the users enter their search queries, and then click the Search button 022 to run them. The user can also choose to run the search privately, wherein the system returns the machine determined results and does not share the search query with the user's sharing network, by clicking the Private button 021. The users can set the default mode of the system by selecting ‘Share’ or ‘Don't share’ with the Default Status link at 019. If the user sets the Default status to ‘Share’, the user's queries are shared with the sharing network by default. When the user sets the Default status to ‘Don't share’, the queries are not shared with the sharing network by default. When the user enters a search query and runs it by clicking Search 022 or Private 021, the system returns the machine determined results in the format shown in 027 wherein the user sees a list of short paragraphs, each consisting of a title link, a brief summary, a URL and some options related to each returned document title. On the right side, in the Query Feed panel 046, the interface includes a Question box 025 where the users can enter questions that are directly shared with their sharing network. The user can submit the questions by clicking the Ask button 026. The users also have the option to view and modify the Subnets they are subscribed to and view all subnets available by clicking the Subnets link 023. The user can also invite other users to join them on the system by clicking the Invite link 024. Below the Question box 025, the query feed panel shows all the shared search queries such as 028 and conversations around the shared queries such as 030. It also includes questions asked by users through their sharing network such as 048. Each shared search query is either alone, wherein it hasn't received any replies such as 049, or grouped together with replies written by other users to it, such as 028. Each group of shared query and its replies forms an individual conversation in the query feed, and all replies to a shared query, as well as replies to the replies are grouped into separate blocks within the query feed in the query feed panel 046. For instance, the shared query 028 has received the reply 029 which is grouped together in the conversation block 030. The two panels 045 and 046 are interlinked in the background. When the users enter search queries in the Search box 020 in the search results panel 045 while allowing the query to be shared, the query is copied across to the query feed in the query feed panel 046 and displays as a shared search query such as 049. The shared query 049 then becomes visible to all users in the current user's sharing network, who can then reply to the shared query, which replies become visible to the current user in the same query feed grouped with the original shared query 049, and also become visible to all the users in the current users sharing network.

FIG. 5 shows a detailed view of the elements of a query feed in the query feed panel 046. The top element shows that the user ‘Friend Old’ 051 has searched for ‘FC utrecht’ which is the shared search query 031 of this user. This shared search query however has no replies yet. Another user ‘Friend two’ 052 had previously searched for ‘vacation in barcelona’ 028. This shared query received a reply from user ‘Friend two-2’ 053 who commented ‘when you planning?’ which forms this users reply 029. The original query and its reply are grouped together into a conversation block 030. The user interface also shows the time lapse since the action had taken place, as in 033 where the interface shows the time since the reply 029 was received. Also, a link is provided to allow the user to write back replies to shared queries as well as other replies, such as 032. Finally, the interface also shows a profile picture such as 050 for each user whose shared queries or replies are displayed in the query feed, to make user identification easier and faster.

FIG. 6 is a mock-up of the user interface of another embodiment of the present invention wherein the query feed is embedded within an existing generic search engine either through server side code or client side code such as a browser plug-in. This embodiment allows users to continue to use their preferred search engine while also drawing benefit of the collaborative model developed in the present invention through the embedded query feed. The user interface shows a generic search engine 034 with various common elements. A side bar 035 offering navigation options, a search box 038 where the users enter their search queries, such as the current query ‘CRM’ 037. A button which submits the entered search query 039. The results of the search query generated by the search engine algorithm 043 and advertisements displayed by the search engine 036. In addition, this interface includes the embedded query feed 040 which allows the users to share their search queries with their sharing network and see the queries shared by users in their sharing network. One such query shared by the user ‘FriendOne’ is displayed at 041. A reply to another shared query is shown at 044. The query feed panel also includes a navigation box 042 which allows the user to scroll through the query feed. In this embodiment, a user enters the search query in search box 038 of the generic search engine 034 and receives the search results 043 while the search query is also copied across to the user's sharing network and becomes visible in the query feed 040 for all users in the current user's sharing network. The users can reply to shared queries and other replies by clicking the Reply link in the query feed associated with the particular shared query or reply they wish to reply to. This particular embodiment allows the users to continue to use their preferred search engine while gaining the benefit of collaborative shared search. The query feed panel can be embedded through server side code, wherein the generic search engine itself chooses to include such code in its search engine program or through client side code, such as browser plugins, which can embed the query feed into the search engine page from the browser when the user visits the search engine website.

FIG. 7 is a mock-up of the user interface of another embodiment of the present invention wherein the query feed developed in the present invention is incorporated within the social information feed of a generic social network product. This embodiment allows the user to continue to use their preferred social network product and draw the benefit of the innovation of the present invention from within the interface and system of their preferred social network product. In this embodiment, while the search queries are shared within the generic social network product, the queries are captured from within the social network product or from user activity outside the social network product using interlinking code that transmits user's search queries from the point where they are conducted to the social network product. The user interface consists of a generic social network interface 054, a sidebar 056 for navigation, a search box 060 with a submit button 064. The current user's profile picture 068 with the user's username 070 and a button 072 for managing the social network account are also provided along with a dashboard 066 which displays recent updates. The interface also provides a feature whereby the users can share information with their sharing network of users on the social network by writing into the sharing box 058 and submitting the content by clicking the button 062. Below the sharing box the interface provides for a list of items 084 shared by the user and the users in the current user's sharing network. The nature of items shared can vary and may include new relationships, new locations and shared photographs among other items. In one embodiment of the integration of the present invention within a generic social network, the search queries run by the users are also shared within this list 084. 082 shows an example of a shared item of information. 080 is a search query that is shared with the user's sharing network within the social network product using the sharing list 084. Similarly 078 is another shared search query and 076 the reply to it. The search query and its reply are grouped together in a conversation block 074.

FIG. 8 is a mock-up of the user interface of another embodiment of the present invention wherein the query feed is incorporated into the search module of a generic social network product. In this embodiment the search is conducted within the social network product and both results and shared queries displayed within the search module of the social network system. The interface consists of a generic social network search page 086 consisting of a search box 094, with a submit button 096. The social network search results are displayed at 088 while the web results are displayed at 090. Finally, a query feed is embedded in the page at 098 which allows the users to share their search queries with other users in the system and see their search queries as well. The query feed can be integrated in various other models in a social network system, besides the illustrative models described here, but in each case it allows for users to collaborate around search by sharing their search queries with other users.

FIG. 9 is a mock-up of the user interface according to a particular embodiment of another innovation of the present invention wherein a user can control the search algorithm used by the search engine to rank order results by controlling the weightings assigned to different parameters factored into the search algorithm. The interface consists of a generic search engine interface 100 consisting of common elements such as a search box, results list, sidebars and advertisements. Included in this interface is an algorithm control panel 102 which allows the user to change the weightings assigned to different parameters factored into the ranking algorithm used by the search engine. Some of the parameters that can be controlled according to this particular embodiment include Keyword Density 104, Links Quality, Page Freshness, Page Quality, and Friend Recommendations among others. The actual parameters used in a given embodiment can vary from the above list. The interface also includes a user interface element tracker 106 which allows the user to move a control button 108 right or left to increase or decrease the weightings assigned to the given parameter. The scroll bar 110 at left allows the user to see more parameters available for customization. When the user changes the weightings, the user clicks the refresh button 112 to receive the re-ordered results in the results section 114. All search engine ranking algorithms assign some default weight to every relevant parameter whereby that parameter impacts what rank the link, document or resource acquires in the results rank ordering. The present innovation allows the user to change these weightings very easily to customize the rank ordering of results according to required preferences so that the users can receive more relevant results based on their requirements. For instance, a user looking for documents with greater occurrence of a given keyword could increase the weighting assigned to the keyword parameter and receive re-ordered results showing high keyword occurrence documents on top. Another user concerned about receiving outdated information, might increase the weighting assigned to page freshness to get most recently updated documents at the top of his search results. The model discussed here is just one possible embodiment of the present innovation which can be implemented in various other ways as well.

FIG. 10 is a mock-up of the user interface according to a particular embodiment of another innovation of the present invention wherein a user can see other users who are currently searching for the same item the user is searching for. These other users can include those within the user's sharing network or outside such network. The innovation in this particular embodiment is embedded within a generic search engine allowing the user to continue to use his preferred search engine, while creating the opportunity for user to collaborate with other users who are engaged in the same or similar information search. The user interface consists of a generic search engine results page 116 consisting of common elements such as search box, results section and navigation sidebar. Included in this interface is a collaboration panel 118 which shows a list of other users who are searching for the same item concurrently. In this embodiment, the list consists of profile pictures of other users 120, 124, which when hovered over with a mouse shows their username and other information 122. The collaboration panel 118 also provides a navigation box 126 which allows the user to scroll through the list of other users. This innovation allows users to work with others who are also searching for the same item and exchange notes, knowledge or suggestions to help each other achieve their information search objectives.

FIG. 11 is a mock-up of the user interface according to a particular embodiment of another innovation of the present invention wherein a user can see other users who belong to the user's sharing network who have searched for the same item in the past. The searches could have been carried out by these other users from the current user's sharing network concurrently, on the same day, in the same week or any other time frame. This innovation allows the user to consider getting their opinion or guidance on her current information search. The innovation in this particular embodiment is embedded within a generic search engine system allowing the user to continue to use her preferred search engine, while creating the opportunity for the user to collaborate with other users from her sharing network who have engaged in the same or similar information search in the past. The user interface consists of a generic search engine results page 128 consisting of common elements such as query results, search box, navigation sidebar and advertisements. Included in this interface is also a collaboration panel 130 which shows the list of other users who are in the current user's sharing network, who have also searched for the same or similar items recently. In the current embodiment, this list is displayed as a list of profile pictures 132 of users. When a mouse pointer hovers over a profile picture, a popup graphic 134 is activated that displays additional details about the user such as username. The collaboration panel 130 also provides a navigation box 138 which users can use to scroll through the list. Finally, the list of users who have run same or similar searches is split into sub-lists according to the recentness of the search activity of the user, thereby forming a sub-list of users who are running similar searches right now 132, another sub-list of users who ran similar searches earlier today, another sub-list of users who ran similar searches this week 136 and so on. The present innovation allows users to find individuals who can potentially add value to their information search, by offering guidance, notes or suggestions so as to make their information search experience more productive and pleasant.

1. A computer readable medium storing instructions for performing a method comprising:
providing each a plurality of subscribers (S's) a user interface providing a search engine and a display containing search results, shared search queries and replies to the shared search queries;
receiving from one or more S's an identification of the respective S's sharing network of subscribers;
sending messages containing S's search queries to S's sharing network;
receiving replies from S's sharing network and providing such replies on the display.

2. The method of claim 1, comprising:
Receiving results from S's search query to the search engine and providing the results on the display.

3. The method of claim 1, comprising:
providing S an option of maintaining a search query private, which private search query is not sent to S's sharing network.

4. The method of claim 1, comprising:
providing S an option to enter a response to the reply and sending this response to S's sharing network.

5. The method of claim 1, comprising:
providing S an option to send S's search queries to one or more subnets of subscribers.

6. A computer apparatus comprising:
a database containing subscriber (S) account information, sharing networks, search queries, search results, and replies to search queries;
a search engine module for processing S's search queries and returning the search results;
a search messaging module for sending S's search queries to S's network and receiving replies from S's network;
a subscriber interface module for receiving S's search queries and replies and displaying the search queries, results and replies.

7. The apparatus of claim 5, wherein:
the search engine module enables searching of one or more of the World Wide Web, an internal network or database, and public or private data repositories.

8. The method of claim 5, wherein:
the subscriber interface module is a Web-based interface.

9. The method of claim 5, wherein:
the interface module displays a link for sending a reply.

10. The method of claim 5, wherein:
the interface module displays a link for sending S's search query to a subnet of subscribers.

11. The method of claim 5, wherein:
the interface module displays groups of the replies responsive to a given search query.

12. The method of claim 5, wherein:
the interface module accepts S's response to a reply and the messaging module sends the response to S's network.

13. A computer apparatus comprising:
a database containing subscriber (S) account information, sharing networks, search queries, search results, and replies to search queries;
a search engine module for processing S's search queries and returning the search results.

14. The method of claim 13, wherein:
the interface module displays a list of users who are concurrently searching for the same item, or similar items, wherein these other users may or may not belong to the current user's sharing network.

15. The method of claim 13, wherein:
the interface module displays a list of users who belong to the current user's sharing network who have previously searched for the same item or similar items.

16. The method of claim 13, wherein:
the interface module provides a mechanism for the user to modify the weightings of different parameters that factor into the search results ranking algorithm of the search engine thereby allowing the user to customize the search results ranking algorithm.
